(19) United States
(12) Patent Application Publication
(10) Pub. No.: US 2004/0213202 A1
(43) Pub. Date: Oct. 28, 2004

(54) Method and apparatus for identifying communications in an ATM/circuit-switched communication network

(75) Inventor: Hidemasa Funatsu, Phoenix, AZ (US)

Correspondence Address: Tuaoi Communications, Inc., 2432 W. Peoria Avenue, Suite 1181, Phoenix, AZ, 85029, US

(73) Assignee: Tuaoi Communications, L.L.C.

(21) Appl. No.: 09/766,391

(22) Filed: Jan. 19, 2001

(51) Int. Cl. H04L 12/66; H04L 12/56

(52) U.S. Cl. 370/352; 370/395.1

(57) ABSTRACT

A method and system using channel identifiers attached to destination phone numbers in voice communications for identifying an origin of a call in an ATM/voice-switched network, without requiring dedicated customer trunk lines or signaling system seven (SS7) capability. The identification of the origin of the communication, via channel identifiers, is used to provide billing information and/or Centrex service, including individual features provided in Centrex service, in an ATM/voice-switched network. A uniquely assigned channel identifier may be attached to the destination phone number at an ingress ATM switch and detached at an egress telephone switch. The channel identifier is compared to records of existing customers for identification purposes and/or enabling call features.

### BACKGROUND OF THE INVENTION

1. Field of the Invention

The present invention relates to systems and methods for identifying communications between an Asynchronous Transfer Mode (ATM) network and a circuit-switched voice network. More specifically, the present invention discloses systems and methods for enabling identification of data relating to phone calls, between an ATM network and a voice switched network, without dedicating trunk lines for each customer or requiring Signaling System 7 (SS7) functionality, in order to generate billing records.

2. Related Art

The telecommunications industry is a rapidly changing technology environment. The increase in competition between telecommunication providers constantly drives the need to increase functionality, speed and bandwidth, while concurrently reducing equipment costs for providing connectivity and services. ATM is a high bandwidth, low-delay, connection-oriented, packet-like switching and multiplexing technique that is becoming rapidly adopted by the telecommunications industry for voice communications systems. Conventional telephone networks carry voice traffic in a synchronous manner over circuit-switched paths. However, because empty slots are circulating on conventional synchronous networks even when the link is not needed, network capacity is underutilized.

On the other hand, ATM allocates bandwidth on demand by transferring specific-sized cells asynchronously, making it suitable for high-speed connection of voice, data and video communications. By transferring ATM cells (i.e., fragments of a larger set of data) asynchronously, constant data flow may be accomplished through an ATM network without wasting capacity. The ATM network is often referred to a “data link layer” since the functionality of currently available ATM switches is insufficient to perform many commercial telephone services such as caller ID, call forwarding, etc., which are commonly found in more expensive telephone switches.

For voice communications, an ATM backbone or data link layer is connected to a circuit-switched telephone network (e.g., circuit based public switched telephony network PSTN), via a telephone switch. The combination of ATM and circuit-switched networks provide improved utilization of network bandwidth than synchronous switching alone, and enables functionality not capable with the data link layer alone.

One example for interfacing an ATM network with a PSTN is explained in U.S. Pat. No. 5,956,334 to Chu et al., which is incorporated herein by reference. Chu describes an interface system ithat utilizes a telephone switch on each user end, i.e., sandwiching the data link layer. As described by Chu et al., ATM may be implemented as the backbone of a circuit-switched network by employing permanent virtual circuits (PVC) and/or switched virtual circuits (SVC).

PVC's fail to take advantage of ATM routing intelligence capabilities utilized in SVC's because of the administratively provisioned lines required by PVC's. Accordingly, Chu et al. discloses methods for voice communication using SVC's in an ATM/switched voice network with SS7 capabilities.

SS7 is a signaling system that typically employs a dedicated 64-kilobit data circuit to carry packetized machine language messages about each call connected between and among machines of a network to achieve connection control. Chu et al. refers to the SS7 signaling as “transmission of third party set up command.” The use of SS7 by Chu et al. requires a separate dedicated line, hence “third party,” which establishes connectivity and carries information via parameters referred to as “information elements” (IE). For example, the address of the ingress ATM switch and administrative billing information are carried within the called party address IE. Without this information provided, via the SS7 signaling, it is impossible, in the system disclosed by Chu et al., to discern the origination of a phone call, thus accurate billing information would not available for customers without SS7 capabilities.

Systems of the type disclosed by Chu et al. require all customers of the ATM/voice-switched network to possess telecommunications equipment having SS7 functionality, thus, the methods disclosed by Chu et al. are not available to customers who do not have SS7 functionality in their communications equipment.

Since many small business environments have inexpensive or dated equipment, such as a Key Telephone System (KTS) or Private Branch Exchange (PBX) that do not support SS7 functionality, i.e., have no port for SS7, the methods disclosed by Chu et al. are not yet practical for service to the majority of potential customers in an ATM/voice-switched network.

Alternatively, it is possible to provide service over an ATM/voice-switched network without SS7 functionality, when the network is configured with dedicated trunk lines between the ATM switches and telephone switches. The dedicated trunk lines enable identification of essential information for billing purposes, such as caller identification. However, this approach is costly as port costs of the respective switches are extremely expensive.

Each ATM switch and telephone switch has a limited number of ports for communication lines or trunk lines. If a trunk line is dedicated for each customer (e.g., to enable customer identification for billing purposes), the number of ports between the ATM switch and telephone switch limits the number of customers that may be linked through the respective switches. Additionally, network capacity is reduced, as dedicated trunk lines are not always fully utilized.

The reduction of lines that connect switches is essential to reduce port costs that are inherent in telephone/ATM switch connections. If trunk lines are not dedicated for each customer, customer communications traffic is mixed over each line, thereby reducing port costs and increasing bandwidth. However, a problem arises when mixing customer traffic over trunk lines in that the origin of a phone call becomes difficult to track for billing purposes; hence the SS7 signaling required by Chu et al.

U.S. Pat. No. 5,894,475 to Bruno et al., which is incorporated herein by reference, also discloses a switched voice and data ATM network with billing system. Bruno et al. shows collection of billing data in a data collection unit based on signaling information from a CCS7 (common channel system 7; AT&T's version of SS7). Accordingly, the invention described by Bruno et al. is also not yet practical for use by all customers for an ATM/voice-switched communications network, for the same reasons as discussed with respect to Chu et al.

### SUMMARY OF THE INVENTION

It is therefore an object of the present invention to solve at least one of the foregoing problems, by providing methods and systems for collecting phone call information in an ATM/switched voice communications network using a channel identifier.

According to various aspects of the present invention, a method and system for identifying a caller in an ATM/circuit-switched network is provided without requiring SS7 functionality or customer dedicated trunk lines between an ATM switch and telephone switch by attaching channel identifiers to outgoing telephone numbers.

Further aspects of the present invention define a method of communicating over an ATM/circuit-switched network including, inputting a destination telephone number at an input device, attaching a channel identifier to a digit string representing the inputted phone number on an ingress side of the ATM/circuit-switched network; and identifying a caller on an egress side of the ATM/circuit-switched network, based on the attached channel identifier.

Additional aspects of the present invention define an ATM/circuit-switched voice communications network capable of generating billing information without requiring SS7 functionality and dedicated customer trunk lines between an ATM switch and a telephone switch by attaching channel identifiers and determining available call features and billing information based on the channel identifier.

Further aspects of the present invention include methods for identifying a caller in an ATM/circuit-switched communications network having at least one ATM switch and a telephone switch, the method including attaching a channel identifier, via the ATM switch, to an incoming communication, sending the communication, including the channel identifier, via the communications network to the telephone switch, and determining the communication origin based on the channel identifier.

Yet a further aspect of the present invention includes methods for configuring an ATM/circuit-switched network to enable identification of a caller including, configuring an ingress portion of the network to attach a channel identifier to a destination phone number of a communication, configuring an egress portion of the network to collect incoming characters of the communication including the channel identifier and the destination phone number, and programming a processing device to detach the channel identifier from the destination phone number of the communication and identify the caller based on the detached channel identifier.

These and other various aspects of the invention will become apparent as described below in reference to the appended drawing.

### BRIEF DESCRIPTION OF THE DRAWING

As described in reference to the figures, like reference numerals are intended to represent like elements in subsequent illustrations in which:

FIG. 1 is a functional block diagram of an ATM/voice-switched network according to an exemplary embodiment of the present invention;

FIG. 2 is a system for collecting billing information according to various aspects of the present invention;

FIGS. 3-5 is a flow chart detailing a method for identifying a caller over an ATM/voice-switched network without requiring dedicated trunk lines and SS7 functionality, according to one embodiment of the present invention;

FIG. 6 is a table for attaching a channel identifier at an ingress ATM switch according to one embodiment of the present invention; and

FIG. 7 is a process for detaching a channel identifier from a communication over an ATM/voice switched network according to the present invention.

### DETAILED DESCRIPTION OF PREFERRED EMBODIMENTS

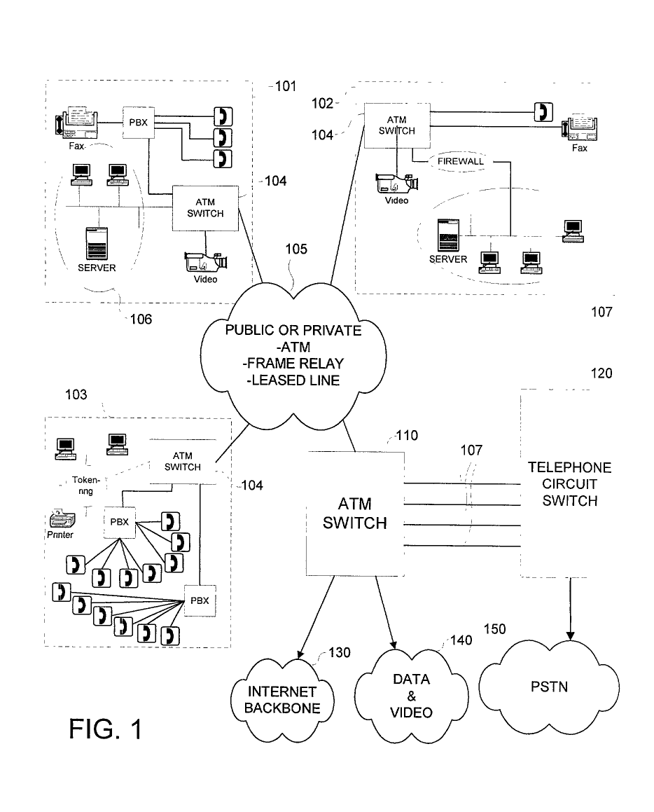

According to one of the various aspects of the invention shown in FIG. 1, an ATM/voice-switched network is illustrated in which customers 101-103 are entities each having respective communications networks including PBXs, internet and network hub servers, etc. Each customer site is connected to an ATM switch 110 through an ATM switching device 104 and communicates through an interconnect network 105, which may be, for example, public or private ATM networks and/or frame relay networks over leased T-1 lines, or any type communication medium capable of carrying communications. The ATM switch 110 routes telephone calls from each customer 101-103 to telephone switch 120, via trunk lines 107.

While ATM switching devices 104 are illustrated as being the only communication outlet from customers 101-103 (i.e., voice, video and data communications are all ATM communications), any communications configuration such as a circuit-switched interface, exclusive of or in addition to, the ATM switch 104 is also contemplated, as not all customers will have exclusively ATM communications portals. Moreover, customers 101-103 could be connected via only circuit-switched voice lines and modems to a local telephone company (acting as interconnect network 105), where the local phone company interfaces to ATM switch 110 on behalf of the customer.

What is important for the present invention is that there is a voice communication interface between a caller and telephone switch 120 via a data link layer or ATM network. However, the following description is given with reference to the example configuration shown in FIG. 1 in which all customers 101-103 have respective ATM switching devices 104. ATM switching device 104 can be any type of programmable communication switch capable of providing local switching functions for customers and adapted to interface with an ATM network, an ATM switching device 104 according to an exemplary embodiment of the present invention is the Nortel Passports® 4400 series programmable ATM switch.

If customer 101 is located in Chicago and is calling customer 102 in Atlanta, conventionally, the only way telephone switch 120 can record that the call is coming from customer 101 is because either: (i) there is a dedicated trunk line 107 from the ATM switch 110 for each customer; or (ii) there is a dedicated signaling line (not shown), for example SS7 signaling, providing that information to telephone switch 120 from ATM switching device 104. These options are undesirable as the costs associated with dedicated trunk lines are burdensome and not all customers have equipment, which facilitate the use of dedicated signaling lines.

Accordingly, it is desirable to mix customer traffic over trunk lines 107 to increase network capacity and reduce the number of ports utilized on the ATM switch 110 and telephone switch 120 without requiring customers 101-103 to have SS7 functionality on their respective communications equipment.

The present invention overcomes these problems and others by providing channel identifiers for voice traffic over an ATM/switched voice network. As described herein, a “channel identifier” (CI) is an identifying piece of information associated with a communication on an ingress side of an ATM/switched voice network (e.g. attached to a DTMF digit string of an outgoing phone call). The channel identifier is used for a variety of purposes including identifying the origin of the communication for billing purposes.

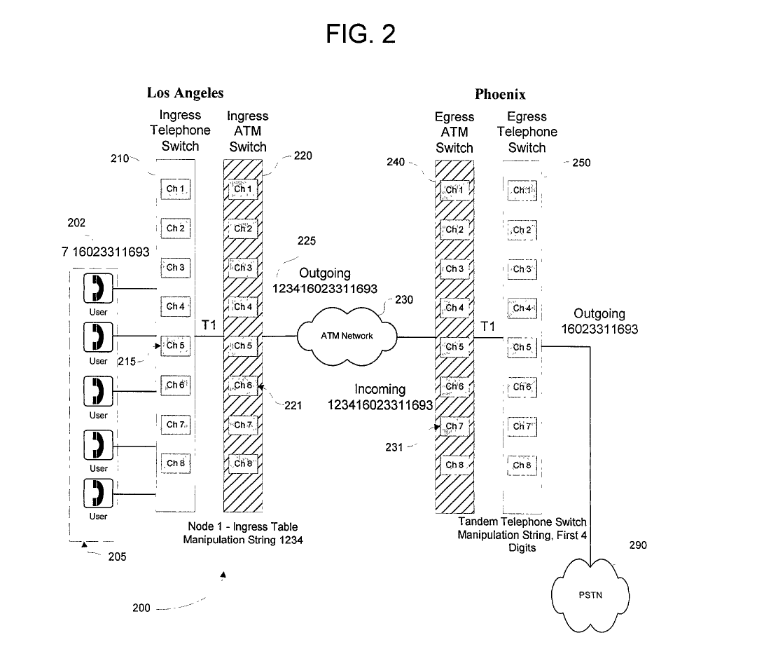

An exemplary embodiment of a voice communication system and method for communications utilizing CIs will now be described with reference to FIG. 2, in which a simplified view of an ATM/voice network 200 is shown. For purposes of illustration, the network 200 is illustrated as having a one-way communication direction from originating node 205 to public switched telephone network (PSTN) 290. However it should be recognized that the present invention equally functions in any direction.

As illustrated in FIG. 2, a call is established when originating node 200 sends outgoing destination phone number digits 202 to an available channel of ingress circuit switching device, for example telephone switch 210, without requiring any SS7 signaling network or third party call setup (Ingress circuit-switching device 210 corresponds, for example, to the PBX of Customers 101-103 of FIG. 1). Outgoing destination phone number 202 includes the destination number including area code and long distance identifier. Also, as required by many customer circuit-switching devices, an outside line identifier, (e.g., a single digit, “7”), is needed to request allocation of an outside line. Ingress telephone switch 210 recognizes that there is an incoming call on a trunk/channel to the switching fabric of the ingress telephone switch 210. Ingress telephone switch 210 allocates a trunk/channel to the incoming call, for example, channel five 215. The telephone number dialed or inputted by a caller or machine is sent over the communication lines as a signal, for example, DTMF (Dual Tone Multi-Frequency) tones, MF (Multi-Frequency) tones, pulse signals, or other known telecommunications signaling methods.

The allocation of trunk/channels is performed according to the local setup of ingress telephone switch 210. For example, a Hunt Group is often used for allocation of available trunk/channels, where a series of telephone lines are organized in a way that if the first line is busy, the next available line is hunted and so on, until an available line is found. Hunt Groups are commonly used by businesses in which a number of potential total users (callers) is greater than an actual number of physical lines provided to the business.

Next, ingress telephone switch 210 selects an available trunk to ingress ATM switch 220 and interconnects the available trunk to the trunk of the incoming call, i.e., trunk/channel five 215. As shown in FIG. 2, the connection between ingress telephone switch 210 and ingress ATM switch 220 is via a T1 line. Iingress ATM switch 220 may be analogous to, for example, ATM switching device 104 illustrated in FIG. 1. T1 is a multi-channel digital transmission link typically split into 24 voice-grade channels. For the purpose of illustration, a single T1 line is shown. However, it should be understood that multiple T1 lines could be present and that the communication link between the respective switches can be any type of communication link used in telecommunications, including digital or analog lines. Moreover, only eight channels have been illustrated in the switches of FIG. 2, but the switches may have any number of channels depending on the variety and cost of the switch.

After connection has been established to ingress ATM switch 220, voice is converted into ATM cells through an ATM/telephone adaptor interface (not shown). Before conversion into ATM cells, ingress telephone switch 210 sends destination phone number 202 to the interface (not shown) of ingress ATM switch 220. The interface of ingress ATM switch 220 then adds a channel identifier 225 (e.g., manipulation string 1234) to the destination phone number 202 and the information is then converted into ATM cell format including a header and payload. The ATM cell payload carries the destination phone number 202 and channel identifier 225 for later use. In the present embodiment, the telephone switch interface of ATM switch 220 adds the channel identifier 225 to the destination phone number 202 before conversion into ATM cells. However, it should be recognized that the circuit-switching device 210, at the customer site as well as the telephone company or any other number of configurations, could also add the channel identifier 225. Moreover, the channel identifier 225 and destination phone number 202 are carried in one, or a sequence of ATM cells, during the connection process.

Channel identifier 225 may be any numeric/alphanumeric character or symbol (or combination thereof) used for uniquely identifying the ATM switching device 104 of each customer site or unique to each incoming trunk/channel or hunt group of each customer site (i.e., manipulation string 1234 is unique to channel five 215 which can determine the hunt group identifying specific users of a customer site). Moreover, the CI 225 can be attached at any location on the destination phone number as described in further detail below.

Once the channel identifier 225 is attached to destination phone number 202, or concurrently therewith, the ingress ATM switch 220 issues a conventional call setup command to establish communications through the ATM network 230 to egress ATM switch 240. Egress ATM switch 240 may be analogous to, for example, ATM switch 110 illustrated in FIG. 1. The call setup command indicates that the destination ATM address (e.g., egress ATM switch) for the call is a circuit connected to egress telephone switch 250. The call is set up via a switched virtual circuit (SVC) through ATM network 230. Since the establishment of SVCs, or ATM routing is conventionally known, it will not be discussed here in significant detail. It is important to understand that, as long as the destination phone number 202 along with channel identifier 225 are passed through the ATM network 230 into egress ATM switch 240, the present invention will be effective and thus, connection through the ATM network 230 in any manner is sufficient.

Egress ATM switch 240 then selects an available trunk/channel to the circuit switching device or egress telephone switch 250, which in turn, collects the destination digit string and interconnects an available trunk to PSTN 290 with the SVC created between ingress ATM switch 220 and egress ATM switch 240. The telephone interface of the egress ATM switch 240 reconverts the transported ATM cells into signals, for example, DTMF tones, MF tones, pulse signals or any other know telecommunications signaling method, and sends the destination digit string, which includes channel identifier 225 and destination phone number 202, to egress telephone switch 250. Egress telephone switch 250 collects the destination digit string, strips off the channel identifier 225 and stores the channel identifier 225 and destination phone number 202 in memory, usually in the form of call accounting tables. The call from originating node 200 is then put through PSTN 290 in a conventional manner.

For billing purposes, egress telephone switch 250 now maintains a call accounting table that includes at least, the channel identifier 225 of the originating phone call, the destination phone number 202 and a length of time the caller and receiving entity were connected. The call tables stored in the telephone switch 250 can be calculated and placed into any standard customer-billing format. Alternatively, the egress telephone switch 250 can be polled by an external source via FTP (file transfer protocol) or any conventional manner in which information may be retrieved from telephone switch 250. In this manner, billing is accomplished in an ATM/voice-switched network without requiring customers to have SS7 functionality or dedicated customer lines between ATM and telephone switches.

With the present invention, the ingress ATM switch 220 can be any manufacturer's model that has programmable features to allow configuring the switch interface to attach digits (channel identifier) to the destination phone number string (if manufacturing the switch to contain and attach various channel identifiers, the switch may not be required to be programmable after manufacturing). As previously discussed, the switch utilized in a preferred embodiment is a Nortel Passport® 4400 series ATM switch having these capabilities. The 4400 series is mainly used for end ATM termination and/or light bridging. In this embodiment of the present invention, only the ingress ATM switch 210 requires the ability to add CIs since the remote tandem ATM switches merely convey the digit string in the payload of ATM cell(s) without any interaction with the payload.

On the other hand, the ATM switch 110 illustrated in FIG. 1, or egress ATM switch 240, are preferably although not necessary, large capacity hub-type ATM switches utilized by phone companies. There is no requirement for the egress ATM switch to have programmable features and the preferred embodiment utilizes a Nortel Passport® 6400 series ATM switch.

It is also advantageous that the egress telephone switch 250 have at least CO (Central Office) grade telephone switch functions and features such as call conferencing, call forwarding, DID (Direct Inward Dialing) features, toll-free number identification, etc. A preferred embodiment of the present invention utilizes a Lucent Technologies® EXS CO grade programmable telephone switch. With the egress telephone switch 250 of a preferred embodiment, an on-board computer can compare, identify and generate the information required for identifying and billing customers. However, it should be understood that an external computer could also be programmed to retrieve and format the call information data in the call tables of the egress telephone switch 250, from a remote location, via file transfer protocol (FTP), Internet or any other means for accessing the memory of the egress telephone switch 250. The telephone switch stores entries in call tables, including but not limited to, calling phone number (based on channel identifier) called phone number, and elapsed time of the call.

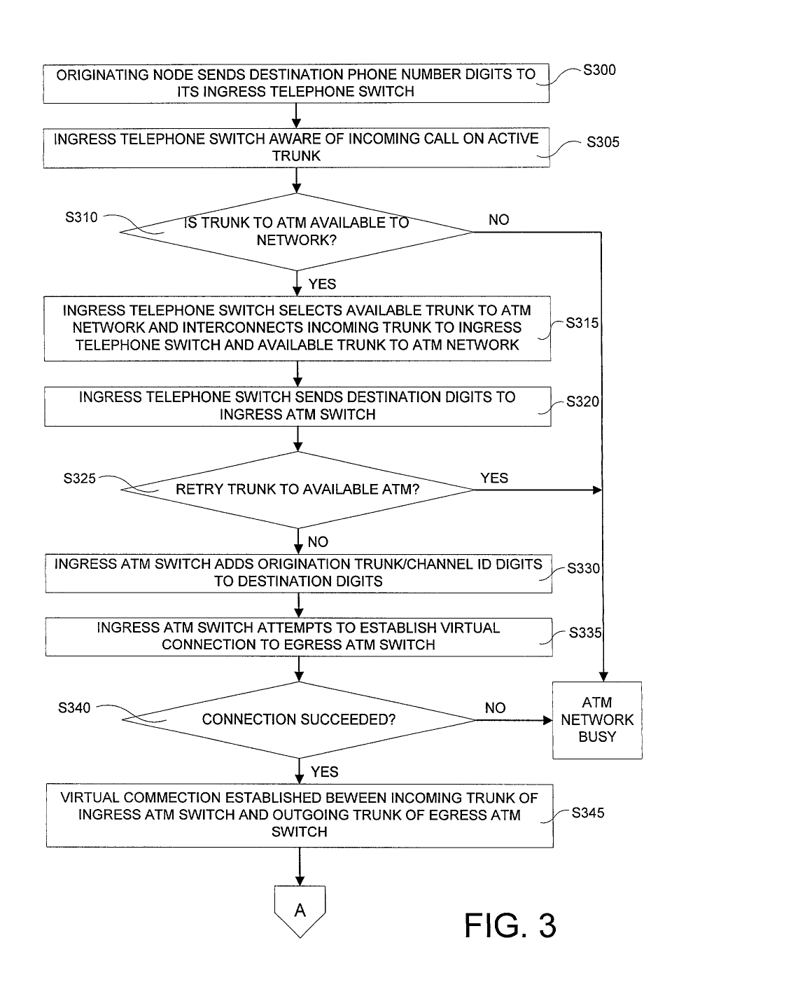

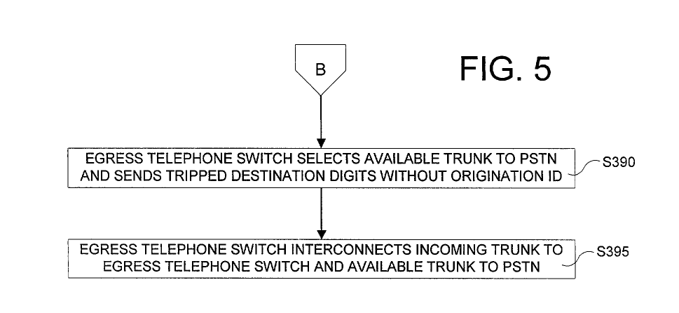

As illustrated by the flow chart of FIGS. 3-5, a preferred method for operation of an ATM/voice-switched network using channel identifiers is described. The method shown in FIGS. 3-5 is similar to that previously described in reference to the operation of the ATM/voice-switched network illustrated in FIG. 2. Therefore, only different aspects are described hereafter. For example, the process illustrated in FIGS. 3-5 takes into account when the ATM network or telephone switches do not function properly or a caller is not properly registered with the network (e.g. a channel identifier is not recognized or is not present) and thus busy signals are provided to a caller or originating node 205.

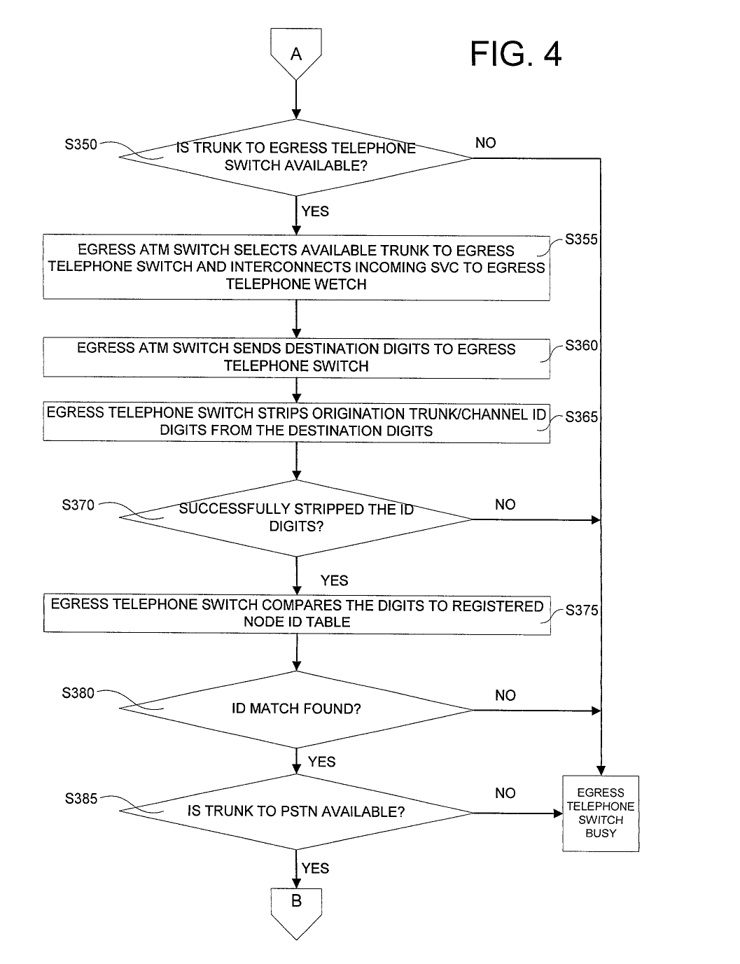

As shown in FIG. 4 at step S375, the egress telephone switch 250 compares the channel identifier 225, stripped from the digit string, with an egress comparison table of registered CIs of originating nodes stored in memory to match identification of the caller. If an ID match is not found, the call is not put through S380 and a busy signal is provided. It should be recognized that the storage of call information, egress comparison tables, CIs, and the described processing relating thereto, can all be performed remotely through a computing device separate from the egress telephone switch 250.

As an optional configuration, if a channel identifier is not detected on the digit string, the egress telephone switch 250 would fail the call as an error. The foregoing options may be desired to ensure that any connection can be properly billed to the call originator.

Additionally, the telephone functionality for the caller can be determined by comparison of the CI to an egress comparison table stored either remotely in a separate computer system or in the telephone switch itself. The egress comparison table may be used to match the CI of a particular caller to the features enabled for that particular customer and provide service accordingly.

According to the specific embodiments describe herein, an ingress ATM switch is configured to add the channel identifier and the egress telephone switch is programmed to collect the digits and potentially, to separate the channel identifier from the destination phone number and identify the caller. However, it will be understood by the skilled artisan that any network configuration may be equally suitable. For example, a PBX or some other circuit-switching device of a customer or telephone company may be configured to add the channel identifier to the destination phone number before reaching an ATM switching devices and/or the egress ATM switch could be configured to remove the channel identifier instead of the egress telephone switch. The precise configuration will significantly depend on the desirability of configuration and capability of the switches of the network. The important factor is that an additional dedicated, or “third party” signaling line is not required because the channel identifier is attached to the destination phone number.

While the channel identifier described above is primarily used for determining caller origin for billing purposes in an ATM/voice-switched network, the use of CIs can also be very helpful in other applications such as providing Centrex service of individual calling features of Centrex service to small business customers. Centrex is a business telephone service offered by local telephone companies from a public exchange. Centrex service is a single line telephone service with added features such as intercom, call forwarding, call transfer, call hold, etc.

Since Centrex service is provided by the local central office (public exchange) of the telephone company, the features have not been available to single line customers over an ATM/voice-switched network due to the identification problems associated with ATM absent SS7 functionality. Accordingly, with the present invention, local telephone companies can provide Centrex service, as well as the individual features available in Centrex service to all customers of an ATM/circuit-switched network.

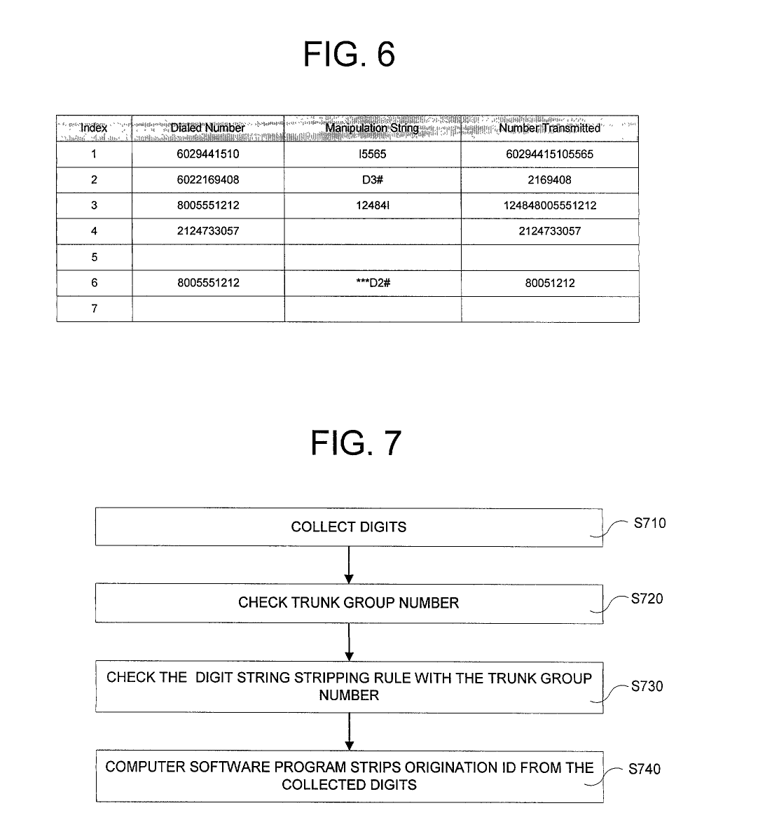

Now, as described with references to FIGS. 6 and 7, configuration of ingress ATM switch 220 and egress telephone switch 250, to perform the above described methods, will be explained in further detail.

The Nortel Passport product of a preferred embodiment provides four configuration management tools: the Command Line Interface (CLI), the Passport 4400 Install Tool, the Passport 4400 Configurator, and the Passport 4400 Mass Deployment Tool. The CLI allows customized programming, via a computer, through a serial port interface. According to one preferred embodiment of the present invention, the CLI is used to program the ingress ATM switch to customize the configuration for adding channel identifiers. In this configuration, an Ingress Table Index is programmed with the CLI to manipulate a number dialed by a caller. For example, at the CLI prompt, the following command is entered:

CLI>[set voice] [ingress table index] (1)

Here, [set voice] informs the ATM to adapt incoming voice communications according to the specified [ingress table index]. FIG. 6 illustrates one example of an ingress table index. For example, index number one stores the manipulation string “15565,” index number two stores the manipulation string “D3#,” and so on, where “I” commands the switch to append channel identifier “5565” to the end of a dialed number (D3#, for example, deletes three digits to the left of the incoming digit string). In the ingress ATM switch of a preferred embodiment, the ingress table index can store up to 32 index numbers and associated manipulation strings. However, for a preferred embodiment of the present invention, only one index and manipulation string is necessary for caller identification. In other words, if the customer site is to be identified by a single channel identifier (e.g. identifying the calls from a customer site as a single entity), one index and manipulation string is used; if each channel or hunt group of the customer site is to be identified (e.g. identifying individual nodes or hunt group associations in a customer site), a different index and manipulation string is associated with each particular channel or hunt group.

Once the ingress ATM switch 220 is configured to add a channel identifier, upon every outgoing dialed number by the customer, the CI programmed according to the ingress table index will be appended to the dialed number. It should be recognized that different models and manufactures of programmable ATM switches may use different commands and features and that this embodiment represents only one specific example of performing this task. The commands used to program various switches are dictated by the manufacturer and thus, with the Nortel switches, commands are available for the switch to be programmed to place a channel identifier at any position in the dialed number.

Additionally, the ingress ATM switch according to a preferred embodiment can be programmed using a Windows® or Sun Solaris® operating system via a serial port or TCP/IP (Transmission Control Protocol/Internet Protocol) data network connection to the switch. It is also an option to program ingress table indexes of an ATM switch or multiple switches remotely via a modem, a T-1 line, or any other type of communications medium configured to communicate with the model of ATM switch being used.

Once the ingress table index is programmed for the ATM switch of customer sites, the egress telephone switch 250 is configured to collect the digit string from an incoming communication over the ATM network and a computer program is used to manipulate the digit string as desired. As illustrated by the flowchart of FIG. 7, an exemplary method is outlined by collecting the digits of the incoming communication S710, checking the trunk group number of the incoming communication S720 and calling the digit string stripping rule associated with the trunk group number of the incoming communication S730 and stripping the channel identifier from the collected digits for identification purposes S740.

In the egress telephone switch according to a preferred embodiment, the incoming digit string normally facilitates the connection of the call and thus consists of the destination phone number only. However, the Lucent switch has a features in which a hex code can be used to collect the digit string for other purposes. The following hex code is the command to configure the Lucent EXS telephone switch to collect the digit string(s) transmitted from the egress ATM switch 240:

0xBC (2)

The command may be entered using any operating system on any type of computer system as well as any device configured to send electrical signals (based on hex commands) over a communications port to the telephone switch. When this particular model of Lucent switch receives the electrical signals of the foregoing hex command through a serial port, it is configured to collect the digit string including the destination phone number 202 and channel identifier 225 of all calls and store them in a memory. A basic computer program resident in the telephone switch or on an external computer system manipulates the collected digits any way desired. For example, a C language program may be configured on a remote system and used to count the total number of digits in the string, apply a stripping algorithm associated with the trunk group of the incoming call, and strip the channel identifier 225 from the destination phone number 202 according to the stripping algorithm. The program may also be configured to compare the stripped channel identifier to a table of existing registered users for identifying purposes and association of enabled caller functions and features. Additionally, the program may be easily configured to create a database of call information of the telephone switch (e.g. billing data). Any table of existing registered users would be previously created based on the registered user billing information, requested call functions and feature, and the channel identifier.

It is also contemplated by the inventor that the program may be implemented in CMOS logic, programmable logic arrays, micro-controllers and any other processing technology that may be either resident in the telephone switch or remotely located.

While it is apparent that a single stripping algorithm can be used for all calls in which the channel identifiers are appended in the same manner (e.g., all ingress ATM switches of every customer are programmed to add the same amount of digits to the same location in every destination phone number), the present inventor contemplates that customers may require ingress ATM switches configured differently according to numerous factors. For example, a densely populated geographical area may require a larger sequence of channel identifiers; certain calling functions of a customer are identified by an additional set of digits; customers from a different carrier network are identified with more or less digits, etc. Any manner in which trunk groups are differentiated, if at all, egress telephone switch may promote the use for different stripping rules. Of course it is not necessary to have different stripping algorithms or trunk groups if not desired.

Unless contrary to physical possibility, the inventor envisions the methods and systems described herein: (i) may be performed in any sequence and/or combination; and (ii) the components of respective embodiments combined in any manner.

The artisan with skill in the art of telecommunications will realize that many features and functions of telephone and ATM switches have not been specifically described and that utilization and/or adaptations of this novel invention are far too numerous to discuss in detail. Accordingly, although there have been described preferred embodiments of this novel invention, many variations and modifications are possible and the embodiments described herein are not limited by the specific disclosure above, but rather should be limited only by the scope of the appended claims.

What is claimed is:

1. An ATM/circuit-switched communications network comprising:
at least one ingress ATM switch;
at least one egress telephone switch operative to communicate with said at least one ingress ATM switch, wherein a channel identifier is attached to at least a portion of a communication over said ATM/circuit-switched network, and wherein an identification of a caller is based on the attached channel identifier.

2. The ATM/circuit-switched communications network according to claim 1, wherein the ingress ATM switch is configured to attach the channel identifier to a destination phone number.

3. The ATM/circuit-switched communications network according to claim 1, wherein the egress telephone switch is configured to collect digits from the portion of the communication with the attached channel identifier.

4. The ATM/circuit-switched communications network according to claim 3, wherein the telephone switch is further configured to separate the collected digits into the channel identifier and a destination phone number.

5. The ATM/circuit-switched communications network according to claim 4, further comprising a processor located at an egress telephone switch side of the ATM/circuit-switched communication network, the processor configured to identify a caller based on the channel identifier.

6. The ATM/circuit-switched communications network according to claim 2, further comprising a processor located at an egress telephone switch side of the ATM/circuit-switched communication network, the processor configured to identify a caller based on the channel identifier.

7. The ATM/circuit-switched communications network according to claim 5, wherein the channel identifier comprises a character string stored in an ingress table index of the at least one ingress ATM switch.

8. A method of communicating over an ATM/circuit-switched network comprising:
inputting a destination telephone number at an input device;
attaching a channel identifier to a digit string representing the inputted phone number on an ingress side of the ATM/circuit-switched network; and
identifying a caller on an egress side of the ATM/circuit-switched network, based on the attached channel identifier.

9. The method of communicating according to claim 8, wherein identifying the caller on the egress side comprises:
collecting the channel identifier and digit string, via a telephone switch;
separating the channel identifier and the destination phone number; and
comparing the channel identifier with a compilation of preassigned channel identifiers to determine whether a matching record is found.

10. The method of communicating according to claim 9, further comprising:
connecting the input device with a receiving device of the destination phone number if a matching record is found; and
preventing connection of the input device with the receiving device if a matching record is not found.

11. The method of communicating according to claim 10, further comprising:
enabling a variety of calling features for the connection based on information obtained from the matching record.

12. The method of communicating according to claim 10, further comprising:
recording call information upon establishing connection with the receiving device, wherein the call information includes at least some data related to billing information.

13. The method of communicating according to claim 11, wherein the variety of calling features is a Centrex service.

14. A method for identifying a caller in an ATM/circuit-switched communications network having at least one ATM switch and a telephone switch, the method comprising:
attaching a channel identifier, via said at least one ATM switch, to an incoming communication;
sending the communication, including the channel identifier, via the communications network to said telephone switch; and
determining the communication origin based on said channel identifier.

15. The method for identifying the caller according to claim 14, wherein the channel identifier comprises a character string stored in an ingress table index of the at least one ATM switch.

16. The method for identifying the caller according to claim 15, wherein there are a plurality of character strings stored in the ingress table index, and wherein a particular character string is selected for attachment as the channel identifier by the at least one ATM switch in accordance with a hunt group of the incoming communication.

17. A method of configuring an ATM/circuit-switched network to enable identification of a caller, the method comprising:
configuring an ingress portion of the network to attach a channel identifier to a destination phone number of a communication;
configuring an egress portion of the network to collect incoming characters of the communication including the channel identifier and the destination phone number; and
programming a processing device to detach the channel identifier from the destination phone number of the communication and identify a caller based on the detached channel identifier.

18. The method of configuring the ATM/circuit-switched network according to claim 17, wherein the processing device to be programmed is one of, a device internal to the telephone switch, or a device external to the telephone switch.

19. The method of configuring the ATM/circuit-switched network according to claim 18, wherein the ingress portion of the network is an ATM switch, and wherein the egress portion of the network is telephone switch.

20. The method of configuring the ATM/circuit-switched network according to claim 19, wherein the ATM switch is configured from a location remote from the ATM switch, and wherein the configuration includes storing at least one manipulation string in an ingress table index of the ATM switch.

21. A method of obtaining billing information in an ATM/voice-switched network including at least one ingress ATM switching device and at least one egress telephone switch, the method comprising:
collecting a character string, via the telephone switch, during a call connection process, wherein the character string includes a destination telephone number and a channel identifier;
associating the channel identifier with a predetermined customer; and
recording information relating to a call, including the customer associated with the channel identifier.

22. The method of obtaining billing information according to claim 21, wherein there are a plurality of customers, at least a portion of which have a customer-site egress ATM switching device, and wherein each customer has at least one unique channel identifier stored in their respective customer-site egress ATM switching devices for uniquely identifying communications originating from each customer.

23. The method of obtaining billing information according to claim 21, wherein after collecting the character string, the method further comprises:
separating the channel identifier from the destination phone number according to a predetermined stripping algorithm.

24. The method of obtaining billing information according to claim 21, wherein associating the channel identifier with a predetermined customer comprises:
comparing the channel identifier with a stored list of customers having preassigned channel identifiers; and
determining which customer a call is originating from based on the comparison.

25. The method of obtaining billing information according to claim 24, wherein at least one of the steps of separating, comparing, determining and recording are performed by an external computer processing device in communication with the egress telephone switch.

26. The method of obtaining billing information according to claim 23, wherein the predetermined stripping algorithm is configured and selected based on a trunk group number of a port on the egress telephone switch on which the character string is received.

27. A channel identifier comprising:
a character string identifying a caller of a communication over an ATM/circuit-switched communication network, wherein the character string is manipulated to be added to a destination phone number on an ATM side of the network, and be separated from the destination phone number on a circuit-switched side of the network.

28. A communications network comprising at least one ingress ATM switch, at least one egress ATM switch operative to communicate with the at least one ingress ATM switch and at least one egress telephone switch operative to communicate with the at least one egress ATM switch, wherein the communications network is configured to generate billing information including identifying an originator of a communication, a destination of the communication, and a length of time of the communication, without requiring,
(i) customer dedicated communication lines between the at least one egress ATM switch and the at least one egress telephone switch; and
(ii) dedicated signaling lines carrying third party caller information.

29. An ATM switching device configured to attach a channel identifier to a digit string representing a destination phone number dialed by a caller in a communications network, wherein the channel identifier is uniquely associated with the caller.

30. A telephone switch configured to collect a string of characters from an ATM switch during a call connection process, wherein the string of characters includes a channel identifier for identifying an originator of the call and a destination phone number.

31. A system for identifying an origin of a voice communication in an ATM/voice-switched network comprising:
means for attaching a channel identifier to the voice communication on an ingress side of the ATM/voice-switched network;
means for removing the channel identifier from the voice communication on an egress side of the ATM/voice-switched network; and
means for comparing the removed channel identifier with a list of predetermined users.
